(19) United States
(12) Patent Application Publication
(10) Pub. No.: US 2026/0046406 A1
(43) Pub. Date: Feb. 12, 2026

(54) ENCODER AND ASSOCIATED SIGNAL PROCESSING METHOD

(71) Applicant: Realtek Semiconductor Corp, HsinChu (TW)

(72) Inventors: Weimin Zeng, San Jose, CA (US); Chi-Wang Chai, Santa Clara, CA (US); Wei Li, Suzhou City (CN); Rong Zhang, Suzhou City (CN); Zhimiao Fan, Suzhou City (CN)

(73) Assignee: Realtek Semiconductor Corp, HsinChu (TW)

(21) Appl. No.: 18/797,469

(22) Filed: Aug. 7, 2024

(51) Int. Cl. H04N 19/124; H04N 19/159; H04N 19/172; H04N 19/176; H04N 19/184; H04N 19/50

(52) U.S. Cl. CPC H04N 19/124; H04N 19/159; H04N 19/172; H04N 19/176; H04N 19/184; H04N 19/50

(57) ABSTRACT

The present invention provides an encoder including a quantization circuit, a quantized data adjustment circuit and an encoding circuit. The quantization circuit is configured to perform a quantization operation on multiple blocks of current frame data in sequence, to generate multiple quantized data respectively corresponding to the multiple blocks. For each of the multiple blocks in the current frame data, the quantized data adjustment circuit adjusts multiple coefficients in the quantized data corresponding to the block according to an optimization level of the block, to generate adjusted quantized data. The encoding circuit is configured to encode the adjusted quantized data of each of the multiple blocks to generate encoded data.

### BACKGROUND OF THE INVENTION

### 1. Field of the Invention

The present invention relates to a video encoder.

### 2. Description of the Prior Art

In the bitrate control operation of a video encoder, if an output bitrate of the encoder is higher, the video quality will be better, but a size the output encoded data generated by the encoder will also be larger. On the contrary, if the output bitrate of the encoder is lower, the video quality will be worse, but a size of the output encoded data generated by the encoder will also be smaller. Therefore, how to design an encoder that can maintain video quality and minimize the size of output encoded data is an important topic.

### SUMMARY OF THE INVENTION

It is therefore an objective of the present invention to provide an encoder and associated signal processing method, to solve the problems described in the prior art.

According to one embodiment of the present invention, an encoder comprising a quantization circuit, a quantized data adjustment circuit and an encoding circuit is disclosed. The quantization circuit is configured to perform a quantization operation on multiple blocks of current frame data in sequence, to generate multiple quantized data respectively corresponding to the multiple blocks. For each of the multiple blocks in the current frame data, the quantized data adjustment circuit adjusts multiple coefficients in the quantized data corresponding to the block according to an optimization level of the block, to generate adjusted quantized data. The encoding circuit is configured to encode the adjusted quantized data of each of the multiple blocks to generate encoded data.

According to one embodiment of the present invention, a signal processing method of an encoder comprises the steps of: performing a quantization operation on multiple blocks of current frame data in sequence, to generate multiple quantized data respectively corresponding to the multiple blocks; for each of the multiple blocks in the current frame data, adjusting multiple coefficients in the quantized data corresponding to the block according to an optimization level of the block, to generate adjusted quantized data; and encoding the adjusted quantized data of each of the multiple blocks to generate encoded data.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram illustrating an encoder according to one embodiment of the present invention.

FIG. 2 is a flowchart of an operation of a quantization parameter calculation circuit according to one embodiment of the present invention.

FIG. 3 shows multiple blocks of frame data.

FIG. 4 is a flowchart of an operation of an optimization level calculation circuit according to one embodiment of the present invention.

FIG. 5 is a diagram of a block group according to one embodiment of the present invention.

FIG. 6 is a flowchart of an operation of a quantized data adjustment circuit according to one embodiment of the present invention.

### DETAILED DESCRIPTION

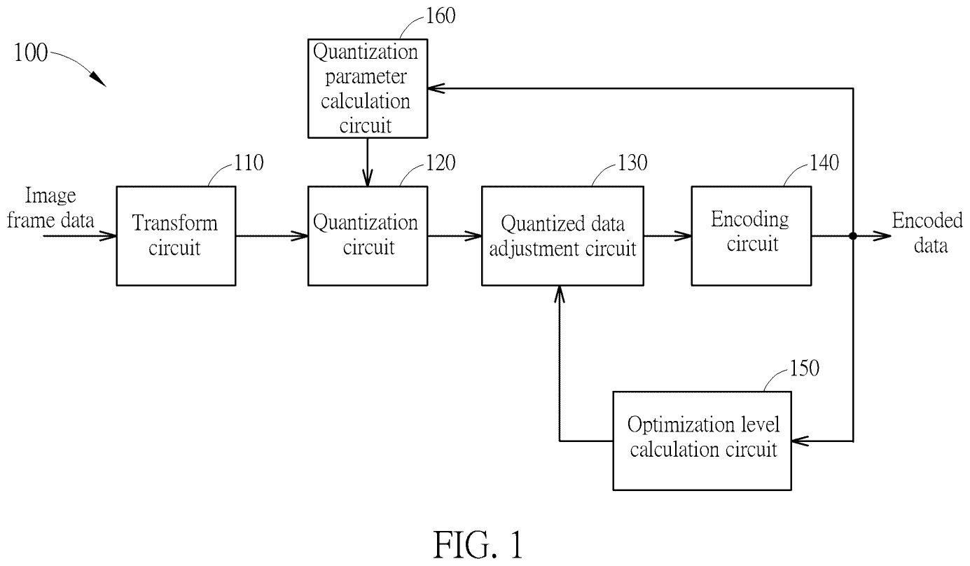

FIG. 1 is a diagram illustrating an encoder 100 according to one embodiment of the present invention. As shown in FIG. 1, the encoder 100 includes a transform circuit 110, a quantization circuit 120, a quantized data adjustment circuit 130, an encoding circuit 140, an optimization level calculation circuit 150 and a quantization parameter calculation circuit 160. In this embodiment, without a limitation of the present invention, the encoder 100 supports the AV1 video coding format formulated by AOMedia.

In the main operation of the encoder 100, the transform circuit 110 performs discrete cosine transform (DCT) upon frame data to generate frequency-domain data. Then, the quantization circuit 120 performs a quantization operation on the frequency-domain data generated by the transform circuit 110 to generate quantized data according to a quantization parameter provided by the quantization parameter calculation circuit 160, in which the quantization operation of each frame corresponds to a quantization parameter, and the quantized data includes multiple sets of coefficients of multiple blocks in the frame data. Next, the quantized data adjustment circuit 130 adjusts a set of coefficients of each block according to the optimization level of the block provided by the optimization level calculation circuit 150, to generate adjusted quantized data. The encoding circuit 140 may be a variable-length code (VLC) encoder, which encodes the adjusted quantized data to generate encoded data, and transmits it to a decoder through a back-end channel (not shown). In addition, the encoded data is provided to the optimization level calculation circuit 150 to determine the optimization level of each block, and is provided to the quantization parameter calculation circuit 160 to calculate the quantization parameters of the next image data (i.e., the next image frame data)

It should be noted that the main operations of the transform circuit 110, the quantization circuit 120 and the encoding circuit 140 in the encoder 100 are well known to those with ordinary skill in the art, and the focus of the present invention lies in the quantized data adjustment circuit 130, optimization level calculation circuit 150 and/or quantization parameter calculation circuit 160, so the following description mainly describes the operations of quantized data adjustment circuit 130, optimization level calculation circuit 150 and quantization parameter calculation circuit 160.

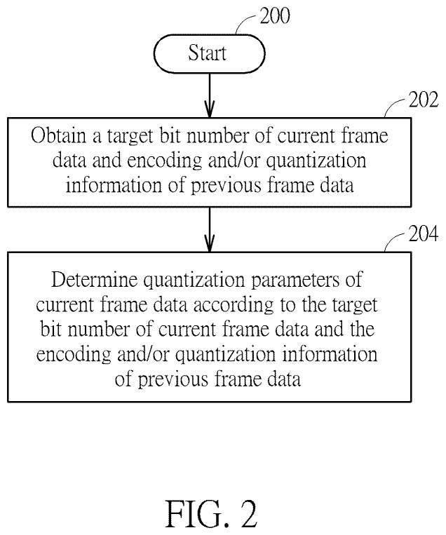

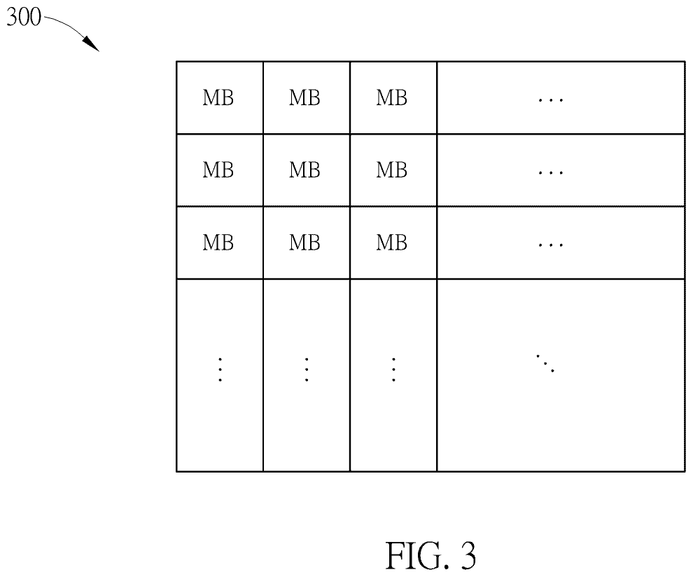

FIG. 2 is a flowchart of an operation of the quantization parameter calculation circuit 160 according to one embodiment of the present invention. In Step 200, the flow starts, and the encoder 100 receives current frame data and starts processing, and the encoder 100 has completed the processing of the previous frame data to generate encoded data of the previous frame data. In Step 202, the quantization parameter calculation circuit 160 obtains a target bit number of the current frame data and the encoding and/or quantization information of the previous frame data. In this embodiment, the target bit number of the current frame data refers to the expected number of bits of the current frame data after completing the encoding operation. For example, assume that the encoder 100 is applied to 4K resolution, a frame rate (frame per second, FPS) is 60, and the transmission rate is 800 Mbps (megabits per second), then the target bit number of the current frame data can be calculated as follows: 800*3840*2160/60=110592000 bits. In addition, the encoder 100 will divide the frame data 300 into multiple blocks (expressed in “MB”) as shown in FIG. 3 when processing the frame data, assuming that the size of each block is 16*16 pixels, the target bit number for each block can be calculated as follows: 110592000/[(3840/16)*(2160/16)]˜3413 bits. In one embodiment, the encoding and/or quantization information of the previous frame data may at least include the quantization parameter of the previous frame data, the bit number of each block, after being encoded, of the previous frame data, the optimization level of each block. The details of the optimization level of each block will be described later.

In Step 204, the quantization parameter calculation circuit 160 determines the quantization parameter of the current frame data based on the target bit number of the current frame data and the encoding and/or quantization information of the previous frame data. In one embodiment, it is assumed that the encoding and/or quantization information of the previous frame data includes the quantization parameter of the previous frame data, the bit number of each encoded block of the previous frame data, and the optimization level of each block of the previous frame data, the quantization parameter calculation circuit 160 can first accumulate the bit number of each encoded block of the previous frame data to obtain the bit number of the encoded data of the previous frame data, and then accumulate the optimization level of each block to obtain a sum of optimization levels, and then divide the sum of optimization levels by the number of blocks in the previous frame data to obtain the average optimization level of a block. In addition, the quantization parameter calculation circuit 160 calculates a threshold value for adjusting the quantization parameter based on the target bit number of the current frame data, wherein the threshold value can be generated through a look-up table method, or the threshold value can be generated by multiplying the target bit number of the current frame data by an adjustment parameter determined by a look-up table. Next, the quantization parameter calculation circuit 160 determines whether the bit number of the encoded data of the previous frame data is greater than the threshold value, and/or determines the relationship between the sum of the optimization levels and multiple adjustment parameters, so as to determine whether to increase or decrease the quantization parameter of the previous frame data to obtain the quantization parameter of the current frame data. For example, assuming that the bit number of the encoded data of the previous frame data is greater than the threshold value, or the sum of the optimization levels exceeds a minimum adjustment parameter among the multiple adjustment parameters, then the quantization parameter calculation circuit 160 increases the quantization parameter of the previous frame data to obtain the quantization parameter of the current frame data, so that the encoded data generated by the encoder 140 encoding the current frame data will have a smaller number of bits. In one embodiment, the adjustment amount of the quantization parameter can be determined according to which of the multiple intervals the bit number of the encoded data of the previous frame data is located, or according to which of the multiple intervals the sum of the optimization levels is located, that is, if the bit number of the encoded data of the previous frame data is higher, or the sum of the optimization levels is higher, the adjustment amount of the quantization parameter will be higher. In addition, assuming that the bit number of the encoded data of the previous frame data is less than the threshold value, then the quantization parameter calculation circuit t 160 decreases the quantization parameter of the previous frame data to obtain the quantization parameter of the current frame data, so that the encoded data generated by the encoder 140 encoding the current frame data will have a greater number of bits, wherein the adjustment amount of the quantization parameter can be determined according to which of the multiple intervals the bit number of the encoded data of the previous frame data is located, that is, if the bit number of the encoded data of the previous frame data is lower, the adjustment amount of the quantization parameter will be higher.

It should be noted that the above detailed calculation method of the quantization parameter calculation circuit 160 is only an example and is not a limitation of the present invention.

After the quantization parameter calculation circuit 160 determines the quantization parameter of the current frame data, the quantization circuit 120 performs a quantization operation on the frequency-domain data generated by the transform circuit 110 to generate quantized data according to the quantization parameter of the current frame data. In one embodiment, the quantization circuit 120 performs the quantization operation on the blocks in the current frame data in sequence, for example, starting from the first row of the frame data 300 shown in FIG. 3, and performing the quantization operation on each block from left to right to generate the quantized data corresponding to each block, where the quantized data of each block includes a matrix with multiple coefficients. Then, the quantized data of each block of the current frame data will be sequentially processed by the quantized data adjustment circuit 130 and the encoding circuit 140 to generate corresponding encoded data.

Since the quantization parameters used by each block in the current frame data are the same, in order to ensure that the encoded data generated by the encoding circuit 140 is lower than the target bit number of the current frame data, the present invention further provides the optimization level calculation circuit 150 and the quantized data adjustment circuit 130 to adjust the quantized data of each block according to the information of each block.

The optimization level calculation circuit 150 is used to calculate the optimization level of each block, where the optimization level can be used to indicate the degree to which the quantized data of the block needs to be adjusted. For example, the higher the optimization level, the quantized data of the block needs to be adjusted to a greater extent to significantly reduce the number of bits of the corresponding encoded data; and the lower the optimization level, the quantized data of the block needs to be adjusted to a lower extent or not adjusted to slightly reduce the number of bits of the corresponding encoded data. In one embodiment, the optimization level calculation circuit 150 can estimate the number of bits of the encoded data and the optimization level of the current block that has not yet been encoded based on the number of bits of the encoded data of some encoded block and their optimization levels, for the operation of the quantized data adjustment circuit 130.

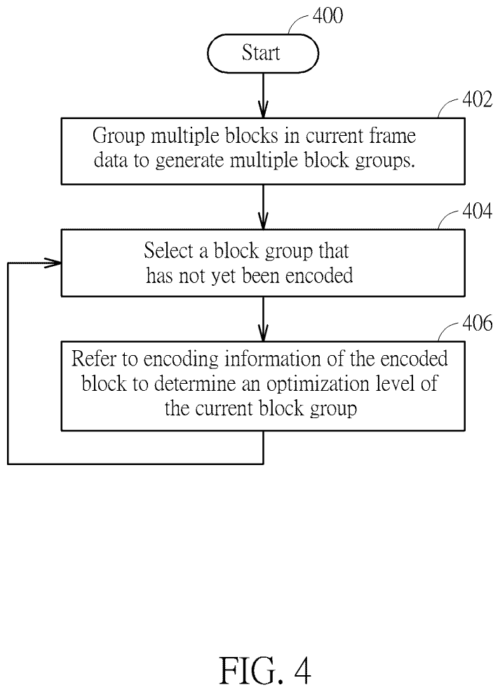

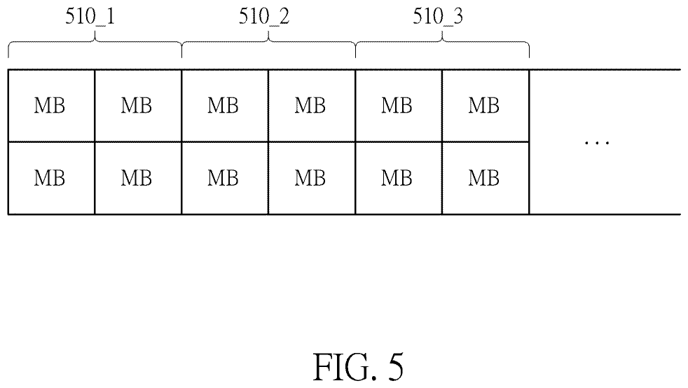

FIG. 4 is a flowchart of an operation of the optimization level calculation circuit 150 according to one embodiment of the present invention. In Step 400, the flow starts. In Step 402, the optimization level calculation circuit 150 groups multiple blocks in the current frame data to generate multiple block groups. Taking FIG. 5 as an example, the optimization level calculation circuit 150 groups multiple blocks to generate the block groups 510_1, 510_2, 510_3, . . . , wherein each block group comprises four blocks, and the multiple block groups 510_1, 510_2 and 510_3 are located in the same row. It should be noted that the number of blocks included in each block group in FIG. 5 is only an example and is not a limitation of the present invention.

In Step 404, the optimization level calculation circuit 150 selects a block group that has not yet been encoded. In Step 406, the optimization level calculation circuit 150 refers to the encoding information of the encoded block to determine the optimization level of the current block group, where the encoding information of the encoded block may include the optimization level and the bit number of the encoded data of the encoded block, etc.

For example, assuming that the selected block group that has not yet been encoded is 510_3, and the blocks in the first row of the block groups 510_1 and 510_2 have been encoded completely and the corresponding encoded data and optimization level have been generated, the optimization level calculation circuit 150 can predict the bit number of the encoded data of the upper left block of the block group 510_3 according to the bit number of the encoded data of the upper left block of the block group 510_1 and the bit number of the encoded data of the upper left block of the block group 510_2, wherein the predicted bit number of the encoded data of the upper left block of the block group 510_3 can be calculated using a weighted average or other suitable methods. Next, since the target bit number of each block in the current frame data is known, the optimization level calculation circuit 150 can determine the total number of bits that can be lent according to a difference between the target bit number and the bit number of the encoded data of the block in the first row of the block group 510_1, and a difference between the target bit number and the bit number of the encoded data of the block in the first row of the block group 510_2. That is, if the total number of bits that can be lent is a positive value, it means that there are more extra bits available for subsequent encoded blocks. Then, the optimization level calculation circuit 150 can determine the optimization level of the block group 510_3 according to the target bit number of the upper left block of the block group 510_3, the predicted bit number of the encoded data, the total number of bits that can be lent, the number of bits in the block groups 510_1 and 510_2, and the optimization levels of the block groups 510_1 and 510_2. In one example, if the predicted bit number of the encoded data of the upper left block of the block group 510_3 is greater than the target bit number, and/or the total number of bits that can be lent is less than a threshold value, the optimization level calculation circuit 150 can obtain the optimization level of the block group 510_3 by increasing the optimization level of the block group 510_2, or obtain the optimization level of the block group 510_3 according to the optimization levels of the block groups 510_1 and 510_2.

In the above embodiments, the blocks in each block group are set to have the same optimization level. Therefore, the optimization level calculation circuit 150 only needs to process one block in each block group, such as the upper left block of each block group in the above embodiment, and the optimization level calculation circuit 150 does not need to use the above calculation steps to determine the optimization levels of the other blocks in each block group.

In the embodiments of FIG. 4 and FIG. 5, only the encoding information of the blocks in the block groups 510_1 and 510_2 is referenced in the process of calculating the optimization level of the block group 510_3, but the present invention is not limited to this. In other embodiments, the number of other blocks referenced in the process of calculating the optimization level of the block group may vary according to the designer's considerations.

In the operation of the quantized data adjustment circuit 130, it is used to adjust the coefficients in the quantized data according to the optimization level of each block, to further control the bit number of the encoded data that is generated by the encoding circuit 140 encoding the block.

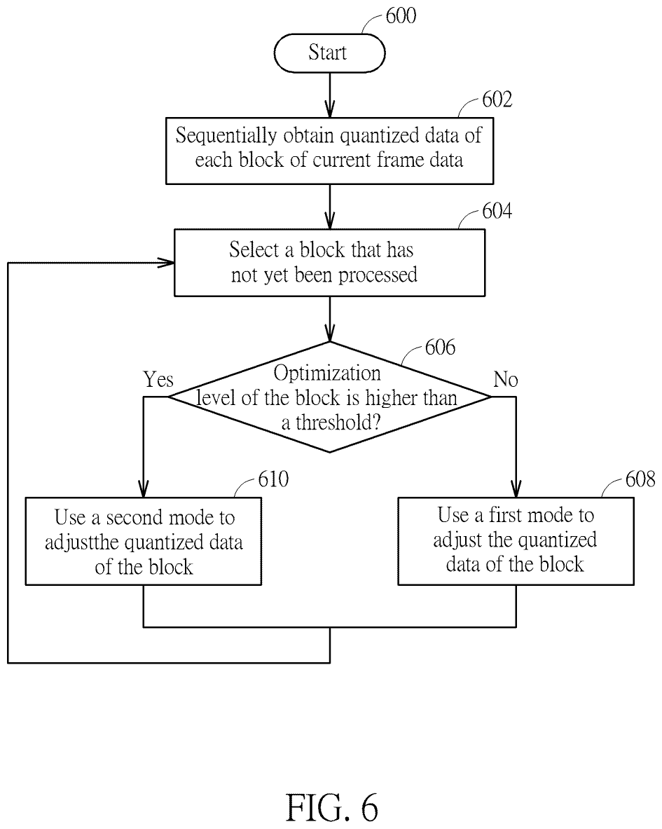

FIG. 6 is a flowchart of an operation of the quantized data adjustment circuit 130 according to one embodiment of the present invention. In Step 600, the flow starts. In Step 602, the quantized data adjustment circuit 130 sequentially obtains the quantized data of each block of the current frame data from the quantization circuit 120. In Step 604, the quantized data adjustment circuit 130 selects a block that has not yet been processed. In Step 606, the quantized data adjustment circuit 130 determines whether the optimization level of the block is greater than a threshold value, if not, the flow enters Step 608; and if yes, the flow enters Step 610.

In Step 608, the quantized data adjustment circuit 130 uses a first mode to adjust the quantized data of the block, wherein the first mode is to slightly reduce multiple coefficients of the quantized data, or not to adjust the multiple coefficients of the quantized data, to generate the adjusted quantized data, wherein the bit number of the encoded data generated by the encoding circuit 140 encoding the adjusted quantized data will be slightly lower than, or it is the same as the bit number of the encoded data generated by the encoding circuit 140 encoding the quantized data. For example, assuming that the quantized data of the block is an 8*8 matrix, that is, the quantized data includes 64 coefficients (their index values are 0-63), and the optimization level of the block is between “1” and the threshold, the quantized data adjustment circuit 130 can first select some of the 64 coefficients, such as a portion of coefficients with index values lower than another threshold value, or a portion of coefficients at the lower right corner of the 8*8 matrix. Then, the quantized data adjustment circuit 130 subtracts a fixed value from the coefficients with positive values among the portion of coefficients, and adds the fixed value to the portion of coefficients with negative values among the portion of coefficients, to generate the adjusted quantized data, wherein the fixed value can be 1, 2, 3, 4, . . . , etc. In addition, if the optimization level of the block is zero, the quantized data adjustment circuit 130 will not adjust the multiple coefficients in the quantized data, that is, the above-mentioned adjusted quantized data will be equal to the quantized data.

In Step 610, the quantized data adjustment circuit 130 uses a second mode to adjust the quantized data of the block, wherein the second mode is to greatly reduce multiple coefficients of the quantized data, wherein the bit number of the encoded data generated by the encoding circuit 140 encoding the adjusted quantized data will be greatly lower than the bit number of the encoded data generated by the encoding circuit 140 encoding the quantized data. In other words, the adjustment amount of the second mode to the multiple coefficients in the quantized data is greater than the adjustment amount of the first mode to the multiple coefficients in the quantized data. For example, the quantized data adjustment circuit 130 can first use the above-mentioned first mode to adjust multiple coefficients in the quantized data to generate a temporarily adjusted quantized data, and then greatly adjust the coefficients in the temporarily adjusted quantized data that are greater than another threshold value, such as directly setting it to “0”, or shifting one bit to the right (i.e., divided by “2”), to generate the adjusted quantized data.

Then, the flow goes back to Step 604 to continue processing the next block.

Briefly summarized, in the encoder and related operations of the present invention, by dynamically adjusting the quantization parameters of each frame data, and/or by calculating the optimization level of each block in the frame data for adjusting the multiple coefficients of the quantized data of the block, the complexity of the hardware circuit can be greatly reduced and the bit number of the encoded data generated by the encoder can be controlled effectively. As used herein, the term “and/or” includes any combination of one or more of the associated listed items.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. An encoder, comprising:
a quantization circuit, configured to perform a quantization operation on multiple blocks of current frame data in sequence, to generate multiple quantized data respectively corresponding to the multiple blocks;
a quantized data adjustment circuit, wherein for each of the multiple blocks in the current frame data, the quantized data adjustment circuit adjusts multiple coefficients in the quantized data corresponding to the block according to an optimization level of the block, to generate adjusted quantized data; and
an encoding circuit, configured to encode the adjusted quantized data of each of the multiple blocks to generate encoded data.

2. The encoder of claim 1, further comprising:
an optimization level calculation circuit, wherein for a current block that has not been encoded by the encoding circuit, the optimization level calculation circuit refers to encoding information of at least one block that has been encoded to determine the optimization level of the current block.

3. The encoder of claim 2, wherein the encoding information of the at least one block that has been encoded comprises an optimization level and a bit number of the encoded data corresponding to the at least one block.

4. The encoder of claim 3, wherein the optimization level calculation circuit calculates a predicted bit number of encoded data of the current block according to the bit number of the encoded data of the at least one block that has been encoded; and the optimization level calculation circuit determines the optimization level of the current block according to the predicted bit number of the encoded data of the current block, a target bit number of the current block, a total number of bits that can be lent, and the optimization level of the at least one block.

5. The encoder of claim 1, wherein if the optimization level of the block is not higher than a threshold value, the quantized data adjustment circuit uses a first mode to adjust the multiple coefficients in the quantized data corresponding to the block to generate the adjusted quantized data; and if the optimization level of the block is higher than the threshold value, the quantized data adjustment circuit uses a second mode, different from the first mode, to adjust the multiple coefficients in the quantized data corresponding to the block to generate the adjusted quantized data.

6. The encoder of claim 5, wherein adjustment amount of the second mode to the multiple coefficients in the quantized data is greater than adjustment amount of the first mode to the multiple coefficients in the quantized data.

7. The encoder of claim 6, wherein if the optimization level of the block is not higher than the threshold value, the quantized data adjustment circuit uses the first mode to reduce the multiple coefficients in the quantized data of the block, or does not adjust the multiple coefficients in the quantized data, to generate the adjusted quantized data of the block; and if the optimization level of the block is higher than the threshold value, the quantized data adjustment circuit uses the second mode to reduce the multiple coefficients in the quantized data of the block, to generate the adjusted quantized data of the block.

8. The encoder of claim 1, further comprising:
a quantization parameter calculation circuit, configured to determine a quantization parameter of the current frame data according to a target bit number of the current frame data and encoding and/or quantization information of previous frame data, for the quantization circuit to perform the quantization operation on the multiple blocks of the current frame data in sequence.

9. A signal processing method of an encoder, comprising:
performing a quantization operation on multiple blocks of current frame data in sequence, to generate multiple quantized data respectively corresponding to the multiple blocks;
for each of the multiple blocks in the current frame data, adjusting multiple coefficients in the quantized data corresponding to the block according to an optimization level of the block, to generate adjusted quantized data; and
encoding the adjusted quantized data of each of the multiple blocks to generate encoded data.

10. The signal processing method of claim 9, further comprising:
for a current block that has not been encoded, referring to encoding information of at least one block that has been encoded to determine the optimization level of the current block.

11. The signal processing method of claim 10, wherein the encoding information of the at least one block that has been encoded comprises an optimization level and a bit number of the encoded data corresponding to the at least one block.

12. The signal processing method of claim 11, wherein the step of referring to the encoding information of the at least one block that has been encoded to determine the optimization level of the current block comprises:
calculating a predicted bit number of encoded data of the current block according to the bit number of the encoded data of the at least one block that has been encoded; and
determining the optimization level of the current block according to the predicted bit number of the encoded data of the current block, a target bit number of the current block, a total number of bits that can be lent, and the optimization level of the at least one block.

13. The signal processing method of claim 9, further comprising:
if the optimization level of the block is not higher than a threshold value, using a first mode to adjust the multiple coefficients in the quantized data corresponding to the block to generate the adjusted quantized data; and
if the optimization level of the block is higher than the threshold value, using a second mode, different from the first mode, to adjust the multiple coefficients in the quantized data corresponding to the block to generate the adjusted quantized data.

14. The signal processing method of claim 13, wherein adjustment amount of the second mode to the multiple coefficients in the quantized data is greater than adjustment amount of the first mode to the multiple coefficients in the quantized data.

15. The signal processing method of claim 14, wherein if the optimization level of the block is not higher than the threshold value, using the first mode to reduce the multiple coefficients in the quantized data of the block, or does not adjust the multiple coefficients in the quantized data, to generate the adjusted quantized data of the block; and if the optimization level of the block is higher than the threshold value, using the second mode to reduce the multiple coefficients in the quantized data of the block, to generate the adjusted quantized data of the block.

16. The signal processing method of claim 9, further comprising:
determining a quantization parameter of the current frame data according to a target bit number of the current frame data and encoding and/or quantization information of previous frame data, for performing the quantization operation on the multiple blocks of the current frame data in sequence.
